(19) United States
(12) Patent Application Publication
(10) Pub. No.: US 2024/0023112 A1
(43) Pub. Date: Jan. 18, 2024

(54) SINGLE DOWNLINK CONTROL INFORMATION (DCI) MESSAGE SCHEDULING BOTH DOWNLINK AND UPLINK COMMUNICATIONS IN FULL-DUPLEX NETWORKS

(71) Applicant: QUALCOMM Incorporated, SAN dIEGO, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/073,315

(22) Filed: Dec. 1, 2022

Related U.S. Application Data
(60) Provisional application No. 63/389,754, filed on Jul. 15, 2022.

(51) Int. Cl. H04W 72/23; H04W 72/1268; H04W 72/1273

(52) U.S. Cl. CPC H04W 72/23; H04W 72/1268; H04W 72/1273

(57) ABSTRACT

A method for wireless communication by a user equipment (UE) includes receiving downlink control information (DCI) including an uplink grant and a downlink grant. The DCI indicates a time domain resource allocation (TDRA) and a frequency domain resource allocation (FDRA). The method also includes determining whether the DCI is a single direction DCI or a bi-directional DCI based on whether the FDRA points to an uplink sub-band, and/or a downlink sub-band. The method further includes communicating in accordance with the DCI.

### CROSS-REFERENCE TO RELATED APPLICATION

The present application claims the benefit of U.S. Provisional Patent Application No. 63/389,754, filed on Jul. 15, 2022, and titled “SINGLE DOWNLINK CONTROL INFORMATION (DCI) SCHEDULING BOTH DOWNLINK AND UPLINK COMMUNICATIONS IN FULL-DUPLEX NETWORKS,” the disclosure of which is expressly incorporated by reference in its entirety.

### FIELD OF THE DISCLOSURE

The present disclosure relates generally to wireless communications, and more specifically to a single downlink control information (DCI) message scheduling both downlink and uplink communications in full-duplex networks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Due to the increasing demand for wireless communications, there is a desire to improve the efficiency of wireless communication network techniques.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method of wireless communication, including transmitting, by a user equipment (UE) to a network entity, a radio resource control (RRC) configuration message indicating a full-duplex capability of the UE; receiving, by the UE from the network entity, a downlink control information (DCI) format message, wherein the DCI format message enables concurrent transmission of an uplink channel and reception of a downlink channel by the UE on a same component carrier, wherein the concurrent transmission and reception comprises a transmission and reception in at least one overlapping orthogonal frequency division multiplexing (OFDM) symbol; and communicating, between the UE and the network entity, based on the DCI format message.

In aspects of the present disclosure, a method for wireless communication by a user equipment (UE) includes receiving downlink control information (DCI) including an uplink grant and a downlink grant. The DCI indicates a time domain resource allocation (TDRA) and a frequency domain resource allocation (FDRA). The method also includes determining whether the DCI is a single direction DCI or a bi-directional DCI based on whether the FDRA points to an uplink sub-band, and/or a downlink sub-band. The method further includes communicating in accordance with the DCI.

In other aspects of the present disclosure, a method for wireless communication by a network component includes transmitting downlink control information (DCI) including an uplink grant and a downlink grant. The DCI indicates a time domain resource allocation (TDRA) and a frequency domain resource allocation (FDRA). The DCI indicates whether the DCI is a single direction DCI or a bi-directional DCI based on whether the FDRA points to an uplink sub-band, and/or a downlink sub-band. The method also includes communicating in accordance with the DCI.

Other aspects of the present disclosure are directed to an apparatus. The apparatus has a memory and one or more processors coupled to the memory. The processor(s) is configured to receive downlink control information (DCI) including an uplink grant and a downlink grant. The DCI indicates a time domain resource allocation (TDRA) and a frequency domain resource allocation (FDRA). The processor(s) is also configured to determine whether the DCI is a single direction DCI or a bi-directional DCI based on whether the FDRA points to an uplink sub-band, and/or a downlink sub-band. The processor(s) is further configured to communicate in accordance with the DCI.

Other aspects of the present disclosure are directed to an apparatus having a memory and one or more processors coupled to the memory. The processor(s) is configured to transmit downlink control information (DCI) including an uplink grant and a downlink grant. The DCI indicates a time domain resource allocation (TDRA) and a frequency domain resource allocation (FDRA). The DCI indicates whether the DCI is a single direction DCI or a bi-directional DCI based on whether the FDRA points to an uplink sub-band, and/or a downlink sub-band. The processor(s) is also configured to communicate in accordance with the DCI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, downlink (DL) channels within a fifth generation/new radio (5G/NR) subframe, a second 5G/NR frame, and uplink (UL) channels within a 5G/NR subframe, respectively.

FIG. 3 is a diagram illustrating an example of a base station and user equipment (UE) in an access network.

FIG. 4 is a diagram illustrating full-duplex communication modes.

FIG. 5 is a diagram illustrating a half-duplex communication mode.

FIG. 6 is a diagram illustrating a full-duplex communication mode.

FIG. 7A is a block diagram illustrating a Type Zero frequency domain resource allocation (FDRA), in accordance with various aspects of the present disclosure.

FIG. 7B is a block diagram illustrating a Type One frequency domain resource allocation (FDRA), in accordance with various aspects of the present disclosure.

FIGS. 8A-8C are block diagrams illustrating intra-slot time domain resource allocations (TDRAs), in accordance with various aspects of the present disclosure.

FIGS. 9A-9B are block diagrams illustrating inter-slot time domain resource allocations (TDRAs), in accordance with various aspects of the present disclosure.

FIG. 10 is a flow diagram illustrating an example process performed, for example, by a user equipment (UE), in accordance with various aspects of the present disclosure.

FIG. 11 is a flow diagram illustrating an example process performed, for example, by a network device, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In conventional systems, a base station may schedule a user equipment (UE) for downlink (DL) and uplink (UL) communications with separate downlink control information (DCI) messages. Merging the two DCI messages into one DCI message in half-duplex networks may create issues because of the independent parameters for each direction (e.g., DL and UL directions). In full-duplex networks, however, the DL and UL grants may share many parameters, which makes the merging of the two DCI messages more reasonable. Thus, one DCI may schedule both DL and UL communications in overlapping resources. However, for a half-duplex UE, the DCI may schedule DL and UL grants with fields that can be interpreted based on the sub-band. Aspects of the present disclosure introduce DCI messages scheduling DL and UL communications for full-duplex UEs in a full-duplex network.

In some aspects of the present disclosure, a base station may send a DCI message scheduling both DL and UL grants for the same UE. When using an existing DL scheduling DCI or UL scheduling DCI, the UE may determine whether it is single direction scheduling or bi-directional scheduling from the frequency domain resource assignment (FDRA) field. For example, if the FDRA points to a frequency allocation contained in DL or UL sub-bands, the UE determines the DCI is for single direction scheduling. If the FDRA points to a frequency allocation contained in both DL and UL sub-bands, the UE determines the DCI is a DL and UL scheduling DCI. Alternatively, or in addition, a different radio network temporary identifier (RNTI) may be dedicated for the DCI scheduling both DL and UL. That is, a DCI scheduling DL or UL may have a cell RNTI (C-RNTI) and a DCI scheduling both DL and UL may have a separate RNTI. In other aspects, a new DCI may be introduced for scheduling both DL and UL transmissions.

In aspects of the present disclosure, the FDRA field in the scheduling DCI may indicate either DL, UL, or both depending on the coverage in the DL sub-band and UL sub-bands. For example, a Type Zero FDRA includes a bitmap with either nine or 18 bits (which may be radio resource control (RRC) configured). Each bit of value ‘1’ in the bitmap is allocated. If the allocation corresponds to a resource block group (RBG) in the DL sub-band, the bit is an allocation for physical downlink shared channel (PDSCH) while if the bit corresponds to an RBG in the UL sub-band, it is an allocation for physical uplink shared channel (PUSCH). For Type One FDRA, a resource indicator value (RIV) indication may be used in a similar manner, such that the indicated bandwidth is split between PDSCH and PUSCH based on the sub-band to which the RIV belongs.

For a time domain resource allocation (TDRA), the UE may be configured with an intra-slot single DCI scheduling DL and UL transmissions. In some aspects, the TDRA field may point to a row in a RRC configured table listing possible time domain resource allocations for both the DL and UL. In other aspects, a single start and length indicator value (SLIV) indication is for both the DL and UL allocations. More specifically, the UE may be RRC configured with a mapping between the SLIV specifying which part is allocated for DL and which part is allocated for UL. In each of these aspects, the UE may apply a guard time between the reception of the DL and transmission of the UL. In still further aspects, the bits describing the SLIV indication are split into two fields for two SLIV values. The first field is for the DL and the second field is for the UL.

The UE may be configured with an inter-slot single DCI scheduling DL and UL transmissions. With inter-slot scheduling (e.g., multiple slots), in some aspects, the TDRA for the DL and for the UL are identical. In these aspects, the TDRA is provided by the scheduling DCI. In other aspects, the TDRA field in the scheduling DCI indicates the TDRA of the DL and UL via an RRC configured mapping between the bits in the TDRA field and the TDRA of the DL and the TDRA of the UL. In other words, there are two separate fields: an uplink field and a downlink field.

Aspects of the present disclosure also address other fields in the DCI. For example, the UE may be RRC configured with a mapping from the DCI fields and the corresponding DL and UL parameters. In one example, the modulation and coding scheme (MCS) parameter is indicated by five bits. The indicated MCS may be the DL MCS, with the UL MCS obtained via an RRC configured offset from the DL MCS. The reference parameter may be defined, for example, by RRC configuration. In other implementations, the five-bit indication points to a pair of DL and UL MCSs, which may be RRC configured. In still other implementations, the pair of MCS parameters can be a function of the TDRA, the FDRA, and possibly other parameters as well.

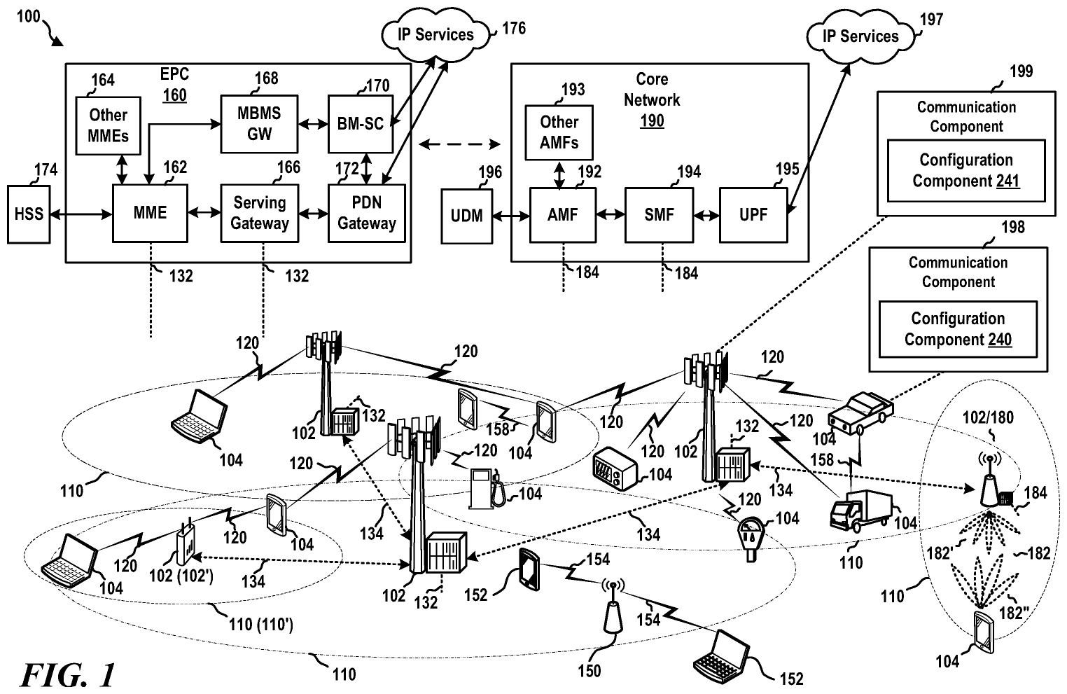

FIG. 1 is a diagram illustrating an example of a wireless communications system and an access network 100 configured for downlink and uplink data downlink control information (DCI) triggering for full-duplex and half-duplex user equipment (UEs) in fifth generation new radio (5G NR). The wireless communications system (also referred to as a wireless wide area network (WWAN)) includes base stations 102, UEs 104, an Evolved Packet Core (EPC) 160, and another core network 190 (e.g., a 5G Core (5GC)).

In certain aspects, the UE 104 may be configured to operate a communication component 198 and/or a configuration component 240 to receive downlink control information (DCI) including an uplink grant and a downlink grant. The DCI indicates a time domain resource allocation (TDRA) and a frequency domain resource allocation (FDRA). The UE 104 may also be configured to determine whether the DCI is a single direction DCI or a bi-directional DCI based on whether the FDRA points to an uplink sub-band, and/or a downlink sub-band. The UE 104 communicates in accordance with the DCI.

Correspondingly, in certain aspects, the network entity (e.g., base station 102) and/or another UE, such as UE 104, may be configured to operate a communication component 199 and/or a configuration component 241 to transmit downlink control information (DCI) including an uplink grant and a downlink grant, the DCI indicating a time domain resource allocation (TDRA) and a frequency domain resource allocation (FDRA), the DCI indicating whether the DCI is a single direction DCI or a bi-directional DCI based on whether the FDRA points to an uplink sub-band, and/or a downlink sub-band. The network entity communicates in accordance with the DCI.

The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as evolved universal mobile telecommunications system (UMTS) terrestrial radio access network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, and 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 10, 15, 20, 100, 400, etc., MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a mobility management entity (MME) 162, other MMEs 164, a serving gateway 166, a multimedia broadcast multicast service (MBMS) gateway 168, a broadcast multicast service center (BM-SC) 170, and a packet data network (PDN) gateway 172. The MME 162 may be in communication with a home subscriber server (HSS) 174. The MME 162 is the control node that processes the signaling between the UEs 104 and the EPC 160. Generally, the MME 162 provides bearer and connection management. All user Internet protocol (IP) packets are transferred through the serving gateway 166, which itself is connected to the PDN Gateway 172. The PDN Gateway 172 provides UE Internet protocol (IP) address allocation as well as other functions. The PDN gateway 172 and the BM-SC 170 are connected to the IP services 176. The IP Services 176 may include the Internet, an intranet, an IP multimedia subsystem (IMS), a packet-switched (PS) streaming service, and/or other IP services. The BM-SC 170 may provide functions for MBMS user service provisioning and delivery. The BM-SC 170 may serve as an entry point for content provider MBMS transmission, may be used to authorize and initiate MBMS bearer services within a public land mobile network (PLMN), and may be used to schedule MBMS transmissions. The MBMS gateway 168 may be used to distribute MBMS traffic to the base stations 102 belonging to a multicast broadcast single frequency network (MBSFN) area broadcasting a particular service, and may be responsible for session management (start/stop) and for collecting eMBMS related charging information.

The core network 190 may include an access and mobility management function (AMF) 192, other AMFs 193, a session management function (SMF) 194, and a user plane function (UPF) 195. The AMF 192 may be in communication with a unified data management (UDM) 196. The AMF 192 is the control node that processes the signaling between the UEs 104 and the core network 190. Generally, the AMF 192 provides quality-of-service (QoS) flow and session management. All user Internet protocol (IP) packets are transferred through the UPF 195. The UPF 195 provides UE IP address allocation as well as other functions. The UPF 195 is connected to the IP services 197. The IP services 197 may include the Internet, an intranet, an IP multimedia subsystem (IMS), a PS streaming service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

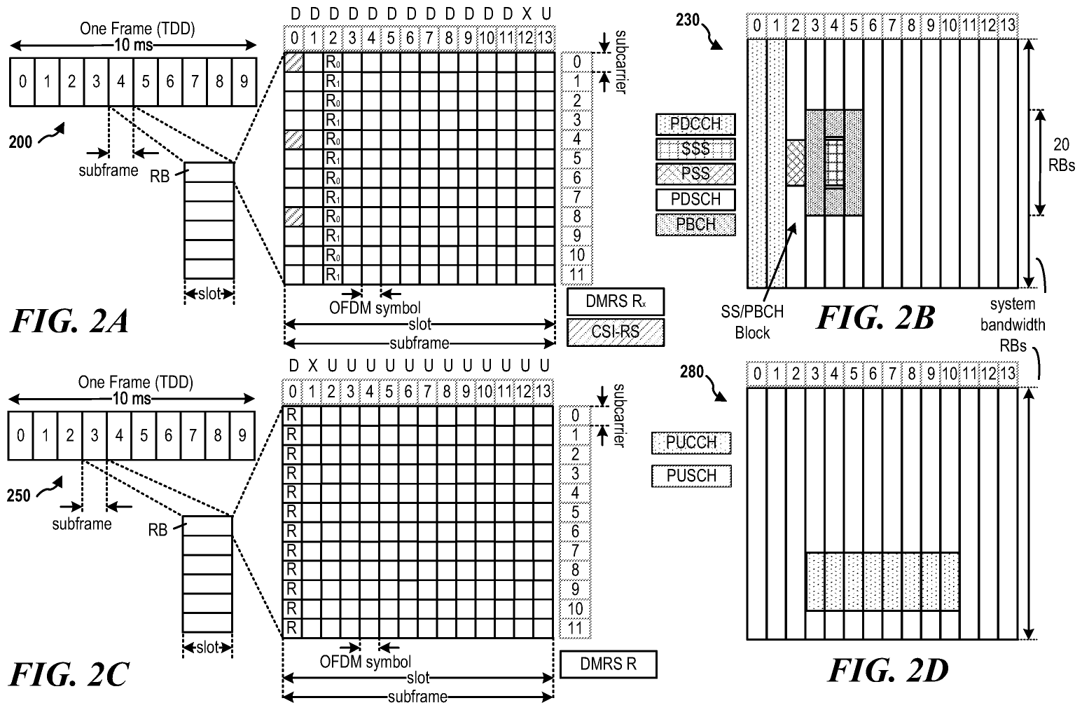

FIGS. 2A-2D include diagrams of example frame structures and resources that may be utilized in communications between the base stations 102, the UEs 104, and/or the secondary UEs (or sidelink UEs) 110 described in this disclosure. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A and 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology 11=0 has a subcarrier spacing of 15 kHz and the numerology 11=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 its.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment/negative acknowledgment (ACK/NACK) feedback. The PUSCH carries data, and may additionally be used to carry a buffer status report (BSR), a power headroom report (PHR), and/or UCI.

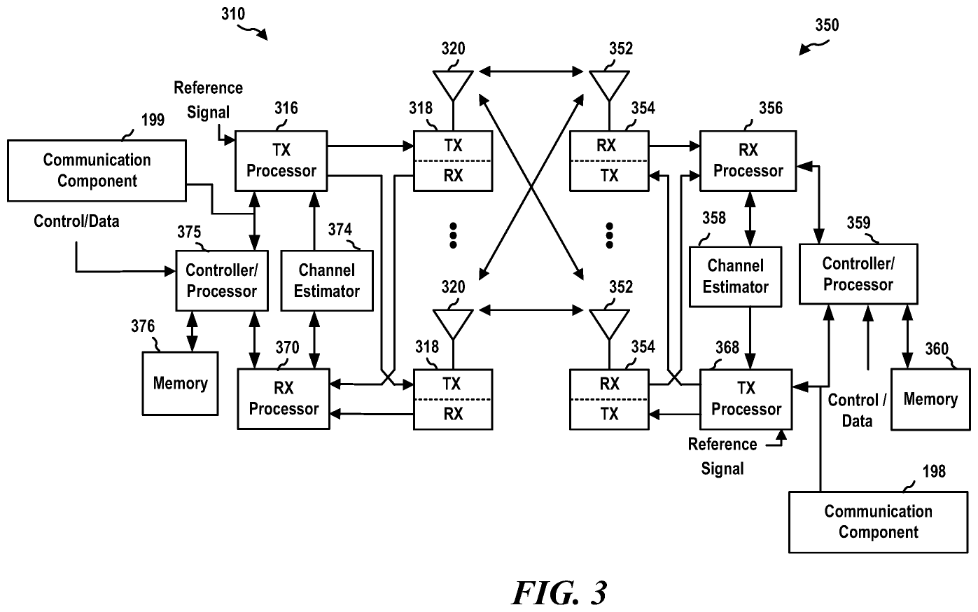

FIG. 3 is a block diagram of a base station 310 in communication with a UE 350 in an access network, where the base station 310 may be an example implementation of base station 102, and where UE 350 may be an example implementation of UE 104. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with communication component 198 of FIG. 1.

At least one of the TX processor 316, the RX processor 370, and the controller/processor 375 may be configured to perform aspects in connection with communication component 199 of FIG. 1.

Currently two separate DCI format messages are utilized when scheduling information for the uplink channel and the downlink channel. DCI format 1_1 schedules information for the downlink channel. In an example, DCI format 1_1 includes fields for frequency domain resource assignment (FDRA), frequency domain assignment Type (Type Zero/One), time domain resource allocation (TDRA), precoding resource block group (PRG) bundling indicator, VRB-2-PRB mapping indicator, carrier indicator, rate matching indicator, zero power (ZP) CSI-RS trigger, TCI-state indication, bandwidth part (BWP) indicator, MCS, new data indicator (NDI), redundancy version (RV) per TB, HARQ Process Number, Antenna port, PUCCH resource indicator, transmit power control (TPC) command for scheduled PUCCH, SRS request, code block group (CBG) transmission information, demodulated reference signal (DMRS) sequence initialization.

DCI format 0_1 schedules information for the uplink channel. In an example, DCI format 0_1 includes fields for carrier indicator, bandwidth part indicator, frequency domain resource assignment, time domain resource assignment, frequency hopping flag, modulation and coding scheme, new data indicator, redundancy version, HARQ process number, TPC command for scheduled PUSCH, UL/supplementary uplink (SUL) indicator, SRS resource indicator, precoding information and number of layers, antenna ports, SRS request, CSI request, CBG transmission information (CBGTI), phase tracking reference signal (PTRS-DMRS association, beta offset indicator, DMRS sequence initialization, and UL-shared channel (SCH) indicator.

Accordingly, DCI format 1_1 and DCI format 0_1 share a number of fields, such as but not limited to, antenna port and SRS request fields.

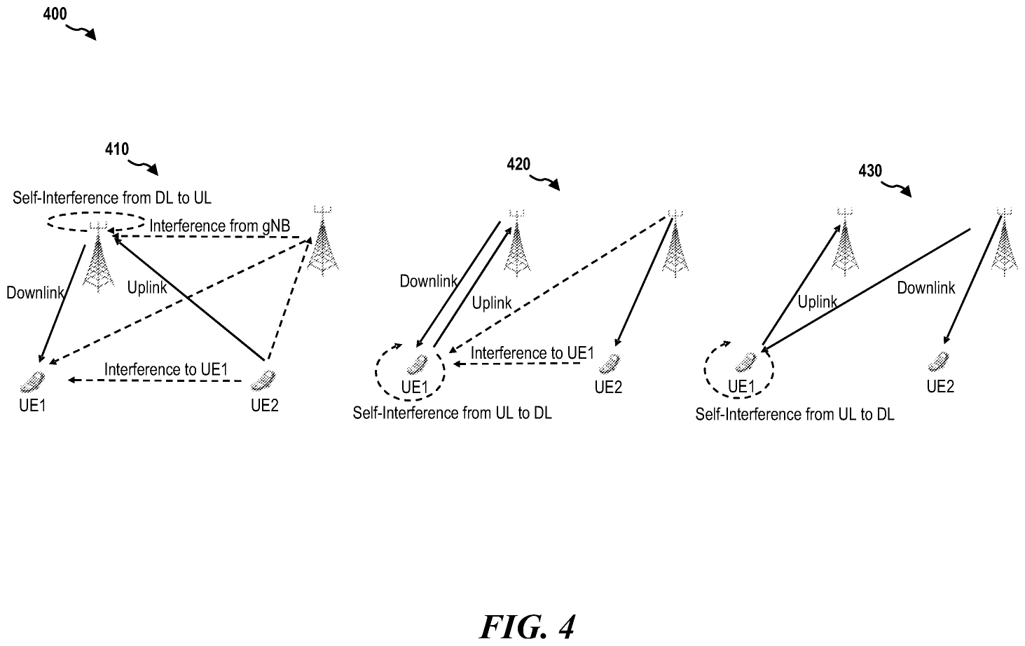

Referring to FIGS. 4-6, the described features generally relate to downlink and uplink data downlink control information (DCI) triggering for full-duplex and half-duplex UEs in fifth generation new radio (5G NR). FIG. 4 is a diagram 400 illustrating full-duplex communication modes. For example, scenario 410 depicts full-duplex base stations with half-duplex UEs 1 and 2. In scenario 410, a full-duplex first gNB may transmit on the downlink channel to UE1 and receive on the uplink channel from UE2. However, UE2 may cause interference on UE1 due to the uplink transmissions to the first gNB. Further, the second gNB may cause interference on the first gNB due to communication with both UE1 and UE2. Additionally, the first gNB may cause self-interference from the downlink and uplink communications.

In an aspect, scenario 420 depicts a full-duplex gNB and a full-duplex UE1. In scenario 420, UE1 experiences self-interference from the full-duplex uplink and downlink communications with the first gNB, from UE2, which receives downlink communications from the second gNB, and from downlink communications from the second gNB.

In an aspect, scenario 430 depicts a full-duplex UE1 using multi-TRP to communicate simultaneously in the uplink with a first gNB and in the downlink with a second gNB. For example, since UE1 is the only entity configured in full-duplex mode, UE1 experiences self-interference due to uplink and downlink communications with both the first gNB and second gNB.

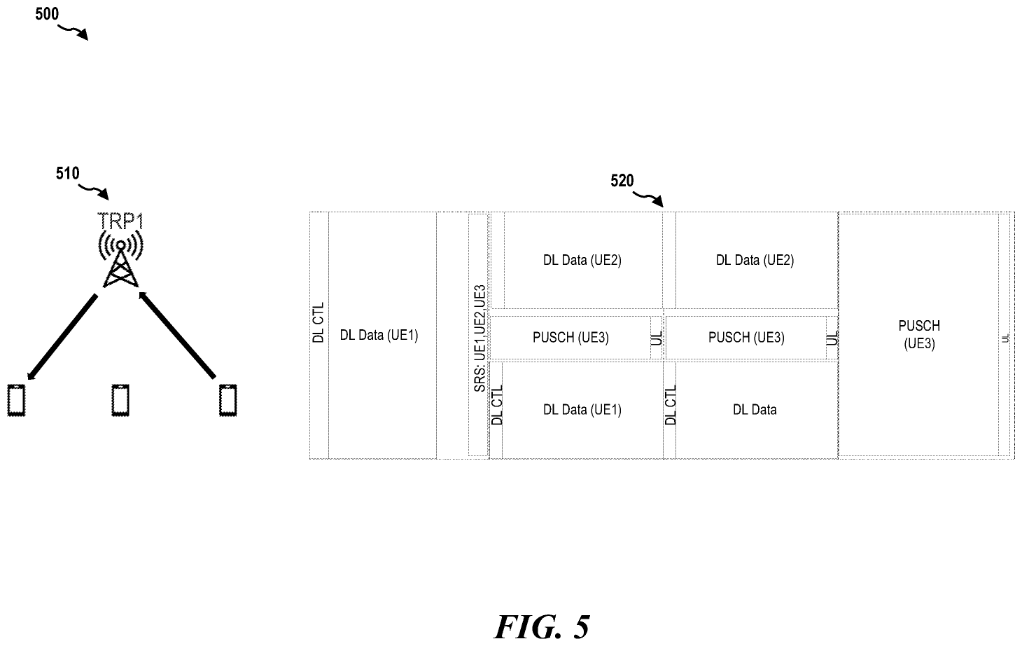

FIG. 5 is a diagram 500 illustrating a half-duplex communication mode. For example, scenario 510 depicts a transmission reception point 1 (TRP1) configured in full-duplex mode with half-duplexed UEs. Correspondingly, diagram 520 depicts a subframe/slot breakdown of the full-duplex TRP1 and half-duplex UEs. In this example, the entities may engage in flexible downlink and uplink operation in time across slots and across UEs. That is, simultaneous PDSCH and PUSCH grant for the same subframe/slot for different UEs may be configured. The UEs may change the uplink transmission and/or the downlink reception bandwidth portion between slots in zero latency. The UEs may transmit sounding reference signals (SRS) with full reciprocity (e.g., full-duplex) to cover the whole downlink bandwidth portion and partial reciprocity (e.g., half-duplex) to cover part of the downlink bandwidth. In this example, the dotted lines of diagram 520 depict the subframe/slot breakdown of the full-duplex TRP1 and half-duplex UEs.

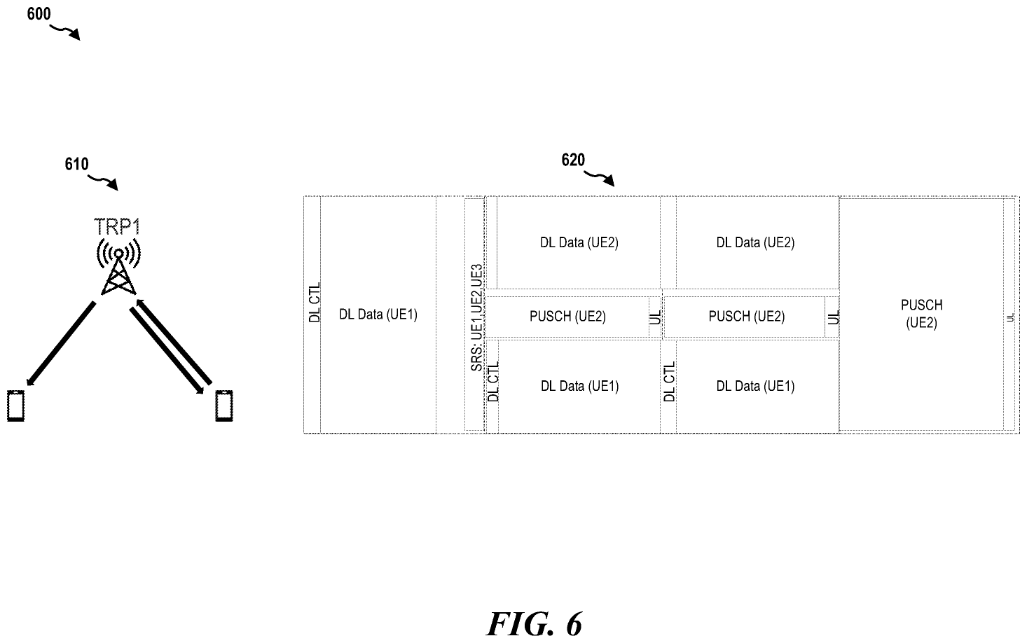

FIG. 6 is a diagram 600 illustrating a full-duplex communication mode. For example, scenario 610 depicts a TRP1 is configured in full-duplex mode with a full-duplexed UE and a half-duplexed UE. Correspondingly, diagram 620 depicts a subframe/slot breakdown of the full-duplex TRP1 and full-duplex UEs. In this example, the entities may engage in flexible downlink and uplink operation in time across slots and across UEs. That is, simultaneous PDSCH and PUSCH grant for the same subframe/slot for different UEs may be configured. The full-duplex UEs may be configured for an uplink and downlink grant. The UEs may change the uplink transmission and/or the downlink reception bandwidth portion between slots in zero latency. The UEs may transmit SRS with full reciprocity (e.g., full-duplex) to cover the whole downlink bandwidth portion and partial reciprocity (e.g., half-duplex) to cover part of the downlink bandwidth. In this example, the dotted lines of diagram 620 depict the subframe/slot breakdown of the full-duplex TRP1 and half-duplex UEs.

In conventional systems, a base station may schedule a user equipment (UE) for downlink (DL) and uplink (UL) communications with separate downlink control information (DCI) messages. Merging the two DCI messages into one DCI message in half-duplex networks may create issues because of the independent parameters for each direction (e.g., DL and UL directions). In full-duplex networks, however, the DL and UL grants may share many parameters, which makes the merging of the two DCI messages more reasonable. Thus, one DCI may schedule both DL and UL communications in overlapping resources. However, for a half-duplex UE, the DCI may schedule DL and UL grants with fields that can be interpreted based on the sub-band. Aspects of the present disclosure introduce DCI messages scheduling DL and UL communications for full-duplex and half-duplex UEs in a full-duplex network.

In some aspects of the present disclosure, a base station may send a DCI message scheduling both DL and UL grants for the same UE. When using an existing DL scheduling DCI or UL scheduling DCI, the UE may determine whether it is single direction scheduling or bi-directional from the frequency domain resource assignment (FDRA) field. For example, if the FDRA points to a frequency allocation contained in DL or UL sub-bands, the UE determines the DCI is for single direction scheduling. If the FDRA points to a frequency allocation contained in both DL and UL sub-bands, the UE determines the DCI is a DL and UL scheduling DCI. Alternatively, or in addition, a different radio network temporary identifier (RNTI) may be dedicated for a DCI scheduling both DL and UL. In other aspects, a new DCI may be introduced for scheduling both DL and UL transmissions.

In other aspects of the present disclosure, the FDRA field in the scheduling DCI may indicate either DL, UL, or both depending on the coverage in the DL sub-band and UL sub-bands. For example, a Type Zero FDRA includes a bitmap with either nine or 18 bits (which may be radio resource control (RRC) configured). Each bit of value ‘1’ in the bitmap is allocated. If the allocation corresponds to a resource block group (RBG) in the DL sub-band, the bit is an allocation for physical downlink shared channel (PDSCH) while if the bit corresponds to an RBG in the UL sub-band, it is an allocation for physical uplink shared channel (PUSCH).

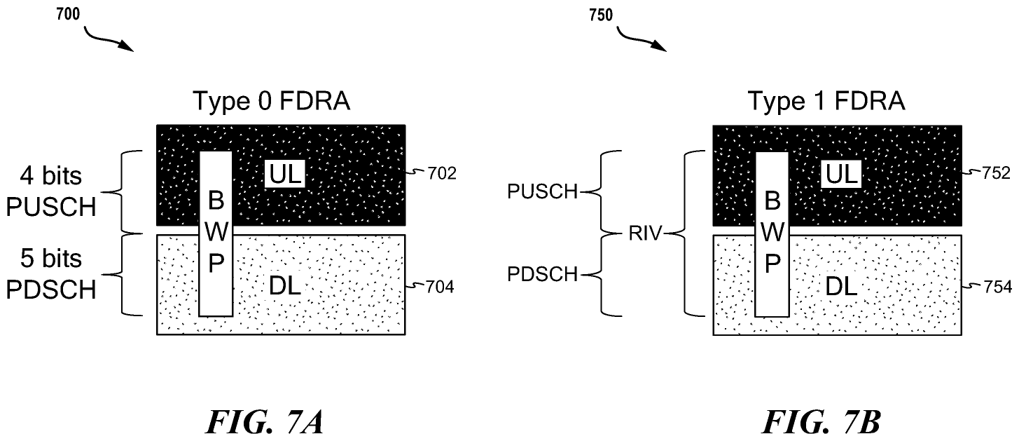

FIG. 7A is a block diagram illustrating a Type Zero frequency domain resource allocation (FDRA) 700, in accordance with various aspects of the present disclosure. In the example of FIG. 7A, the Type Zero FDRA 700 includes nine bits corresponding to RBGs in the active BWP: four bits for PUSCH, and five bits for PDSCH. The Type Zero FDRA 700 in the example of FIG. 7A corresponds to scheduling in both an uplink (UL) subband 702 and a downlink (DL) subband 704.

For Type One FDRA, a resource indicator value (RIV) indication may be used in a similar manner, such that the indicated bandwidth is split between PDSCH and PUSCH based on the sub-band to which the RIV belongs. The RIV indicates a starting location and a length of the allocation.

FIG. 7B is a block diagram illustrating a Type One frequency domain resource allocation (FDRA) 750, in accordance with various aspects of the present disclosure. In the example of FIG. 7B, the Type One FDRA 750 includes an RIV that corresponds to the PUSCH and the PDSCH in the active BWP. The Type One FDRA 750 in the example of FIG. 7B corresponds to scheduling in both an uplink (UL) subband 752 and a downlink (DL) subband 754.

For a time domain resource allocation (TDRA), the UE may be configured with an intra-slot single DCI scheduling DL and UL transmissions. In some aspects, the TDRA field may point to a row in a RRC configured table listing possible time domain resource allocations for both the DL and UL. In other aspects, a single start and length indicator value (SLIV) indication is for both the DL and UL allocations. More specifically, the UE may be RRC configured with a mapping between the SLIV specifying which part is allocated for DL and which part is allocated for UL. In each of these aspects, the UE may apply a guard time between the reception of the DL and transmission of the UL. In still further aspects, the bits describing the SLIV indication are split into two fields for two SLIV values. The first field is for the DL and the second field is for the UL.

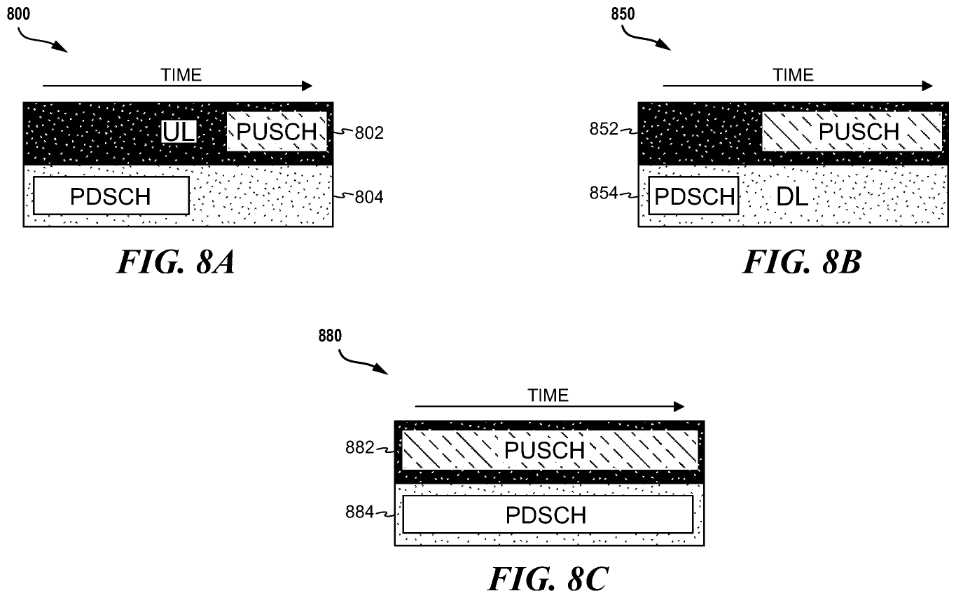

FIGS. 8A-8C are block diagrams illustrating intra-slot time domain resource allocations (TDRAs), in accordance with various aspects of the present disclosure. In FIG. 8A, a first TDRA 800 for an uplink subband 802 and a downlink subband 804 allocates more symbols for PDSCH than for PUSCH. It is noted that after the PDSCH completes, a gap exists before the PUSCH begins. In FIG. 8B, a second TDRA 850 for an uplink subband 852 and a downlink subband 854 allocates more symbols for PUSCH than for PDSCH. It is noted that after the PDSCH completes, a gap exists before the PUSCH begins. In FIG. 8C, a third TDRA 880 for an uplink subband 882 and a downlink subband 884 allocates symbols for the PDSCH and the PUSCH. In the example of FIG. 8C, the PDSCH and PUSCH allocations overlap in time.

The UE may be configured with an inter-slot single DCI scheduling DL and UL transmissions. With inter-slot scheduling (e.g., multiple slots), in some aspects, the TDRA for the DL and for the UL are identical. In these aspects, the TDRA is provided by the scheduling DCI. In other aspects, the TDRA field in the scheduling DCI indicates the TDRA of the DL and UL via an RRC configured mapping between the bits in the TDRA field and the TDRA of the DL and the TDRA of the UL. In other words, there are two separate fields: an uplink field and a downlink field.

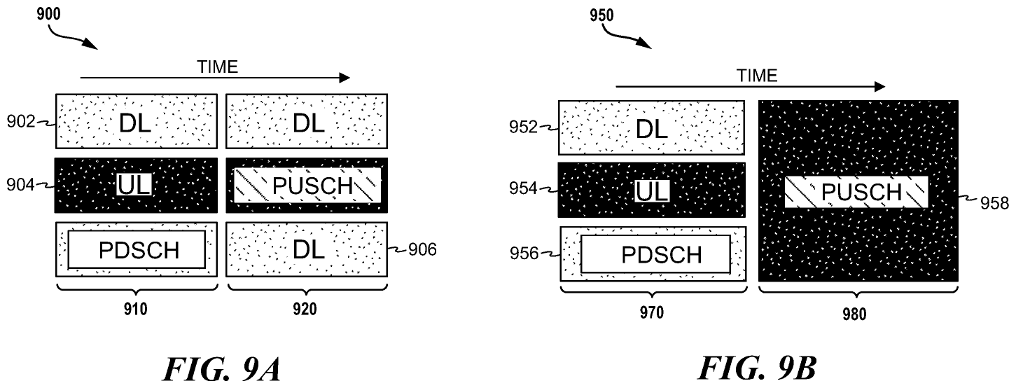

FIGS. 9A-9B are block diagrams illustrating inter-slot time domain resource allocations (TDRAs), in accordance with various aspects of the present disclosure. In the example of FIG. 9A, a first TDRA 900 for a first downlink subband 902, a first uplink subband 904, and a second downlink subband 906 allocates an identical number of symbols for uplink and downlink communications. The first TDRA 900 allocates a PDSCH in a first slot 910, and a PUSCH in a second slot 920. In the example of FIG. 9B, a second TDRA 950 for a first downlink subband 952, a first uplink subband 954, and a second downlink subband 956 allocates symbols for a PDSCH in a first slot 970. The second TDRA 950 allocates symbols for a PUSCH in a second slot 980. The second slot 980 includes a second uplink subband 958 that is a different size than the first uplink subband 954. In the example of FIG. 9B, the TDRA 950 of the DL and UL is indicated via an RRC configured mapping between the bits in the TDRA field and the TDRA of the DL and the TDRA of the UL. In other words, there are two separate fields: an uplink field and a downlink field.

Aspects of the present disclosure also address other fields in the DCI. For example, the UE may be RRC configured with a mapping from the DCI fields and the corresponding DL and UL parameters. In one example, the modulation and coding scheme (MCS) parameter is indicated by five bits. The indicated MCS may be the DL MCS, with the UL MCS obtained via an RRC configured offset from the DL MCS. The reference parameter may be defined, for example, by RRC configuration. In other implementations, the five-bit indication points to a pair of DL and UL MCSs, which may be RRC configured. In still other implementations, the pair of MCS parameters can be a function of the TDRA, the FDRA, and possibly other parameters as well.

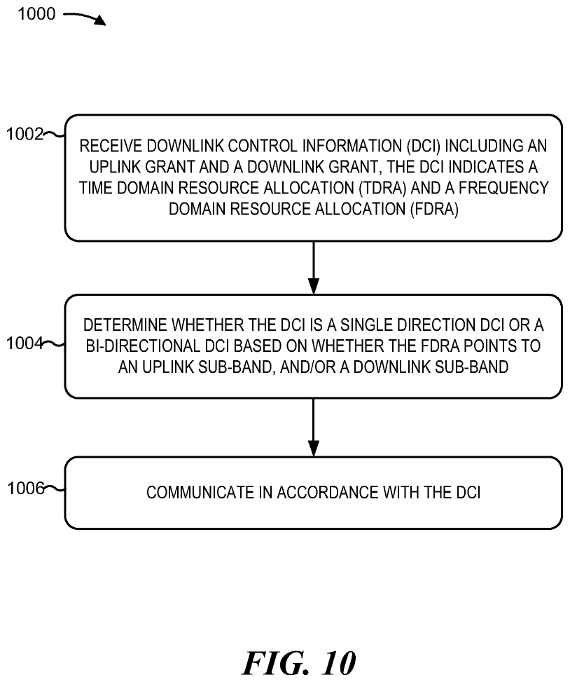

FIG. 10 is a flow diagram illustrating an example process 1000 performed, for example, by a user equipment (UE), in accordance with various aspects of the present disclosure. The example process 1000 is an example of a single downlink control information (DCI) message scheduling both downlink and uplink communications in full-duplex networks. The operations of the process 1000 may be implemented by a UE 350.

At block 1002, the user equipment (UE) receives downlink control information (DCI) including an uplink grant and a downlink grant. The DCI indicates a time domain resource allocation (TDRA) and a frequency domain resource allocation (FDRA). For example, the UE (e.g., using the antenna 352, receiver 354, receive processor 356, controller/processor 359, communication component 198, memory 360, and/or the like) may receive the DCI. The UE may decode the DCI based on a radio network temporary identifier (RNTI) dedicated to both uplink scheduling and downlink scheduling. In some aspects, the FDRA comprises a Type Zero FDRA with a bitmap, and the determining further comprises determining the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band. In other aspects, the FDRA comprises a Type One FDRA with a resource indicator value (RIV), and the determining further comprises determining the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band. The DCI may be for scheduling uplink and downlink in a same slot. In some implementations, the TDRA points to a row in a radio resource control (RRC) configured table including a potential first TDRA for uplink and a potential second TDRA for downlink. In other implementations, the TDRA includes a start and length indication value (SLIV) for uplink and for downlink, the method further comprising receiving a mapping between the SLIV, downlink allocations, and uplink allocations.

A guard time may be applied between receiving a physical downlink shared channel (PDSCH) and transmitting a physical uplink shared channel (PUSCH). The TDRA may include a start and length indication value (SLIV) with uplink bits in a first field and downlink bits in a second field. The DCI may also be for scheduling uplink and downlink in multiple slots. In these implementations, the TDRA may include a first TDRA for downlink that is the same as a second TDRA for uplink. The TDRA may include bits mapped to an uplink TDRA and bits mapped to a downlink TDRA.

At block 1004, the user equipment (UE) determines whether the DCI is a single direction DCI or a bi-directional DCI based on whether the FDRA points to an uplink sub-band, and/or a downlink sub-band. For example, the UE (e.g., using the controller/processor 359, memory 360, and/or the like) may determine whether the DCI is a single direction DCI or a bi-directional DCI. In some implementations, the UE may receive a first mapping between uplink parameters and fields of the DCI, as well as a second mapping between downlink parameters and fields of the DCI. The UE may also receive a configured offset for one of the uplink parameters relative to a reference parameter, the offset and reference parameter indicating one of the downlink parameters and one of the uplink parameters. The UE may receive a configuration for a pair of uplink and downlink parameters, the DCI pointing to the configuration. The uplink parameters and downlink parameters may be a function of the FDRA and the TDRA.

At block 1006, the user equipment (UE) communicates in accordance with the DCI. For example, the UE (e.g., using the antenna 352, receiver 354, receive processor 356, transmitter 354, transmit processor 368, controller/processor 359, communication component 198, memory 360, and/or the like) may communicate in accordance with the DCI.

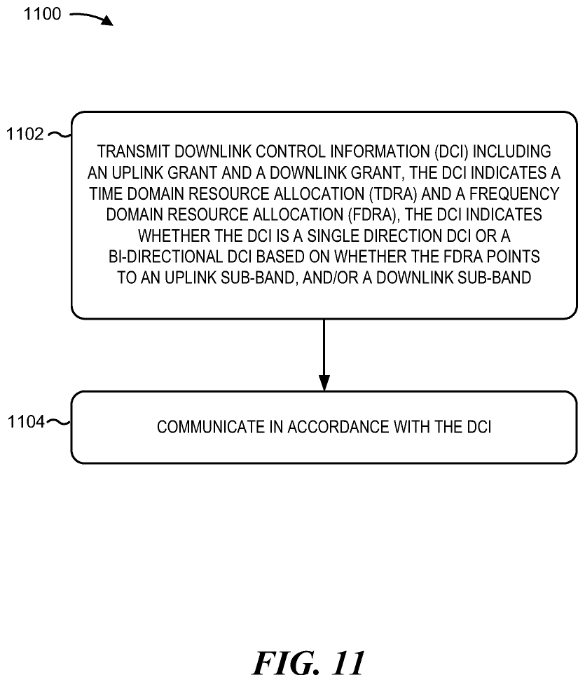

FIG. 11 is a flow diagram illustrating an example process 1100 performed, for example, by a network device, in accordance with various aspects of the present disclosure. The example process 1100 is an example of single downlink control information (DCI) scheduling both downlink and uplink in full-duplex networks. The operations of the process 1100 may be implemented by a network component, such as a base station 310 or a component of a base station.

At block 1102, the network component transmits downlink control information (DCI) including an uplink grant and a downlink grant. The DCI indicates a time domain resource allocation (TDRA) and a frequency domain resource allocation (FDRA). The DCI indicates whether the DCI is a single direction DCI or a bi-directional DCI based on whether the FDRA points to an uplink sub-band, and/or a downlink sub-band. For example, the base station (e.g., using the antenna 320, transmitter 318, transmit processor 316, controller/processor 375, communication component 199, memory 376, and/or the like) may transmit the DCI. The network component may encode the DCI based on a radio network temporary identifier (RNTI) dedicated to both uplink scheduling and downlink scheduling. In some aspects, the FDRA comprises a Type Zero FDRA with a bitmap, and the DCI indicates the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band. In other aspects, the FDRA comprises a Type One FDRA with a resource indicator value (RIV), and the DCI indicates the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band. The DCI may be for scheduling uplink and downlink in a same slot. In some implementations, the TDRA points to a row in a radio resource control (RRC) configured table including a potential first TDRA for uplink and a potential second TDRA for downlink. In other implementations, the TDRA includes a start and length indication value (SLIV) for uplink and for downlink, the method further comprising transmitting a mapping between the SLIV, downlink allocations, and uplink allocations.

The network component may configure a guard time between receiving a physical downlink shared channel (PDSCH) and transmitting a physical uplink shared channel (PUSCH). The TDRA includes a start and length indication value (SLIV) with uplink bits in a first field and downlink bits in a second field. In some aspects, the DCI is for scheduling uplink and downlink in multiple slots. In these aspects, the TDRA may include a first TDRA for downlink that is the same as a second TDRA for uplink. The TDRA may also include bits mapped to an uplink TDRA and bits mapped to a downlink TDRA. The network component may transmit a first mapping between uplink parameters and fields of the DCI, as well as a second mapping between downlink parameters and fields of the DCI. The network component may also transmit a configured offset for one of the uplink parameters relative to a reference parameter, the offset and reference parameter indicating one of the downlink parameters and one of the uplink parameters. The network component may also transmit a configuration for a pair of uplink and downlink parameters, the DCI pointing to the configuration. The uplink parameters and downlink parameters may be a function of the FDRA and the TDRA.

At block 1104, the network component communicates in accordance with the DCI. For example, the base station (e.g., using the antenna 320, receiver 318, receive processor 370, transmitter 318, transmit processor 316, controller/processor 375, communication component 199, memory 376, and/or the like) may communicate in accordance with the DCI.

### Example Aspects

Aspect 1: A method of wireless communication by a user equipment (UE), comprising: receiving downlink control information (DCI) including an uplink grant and a downlink grant, the DCI indicating a time domain resource allocation (TDRA) and a frequency domain resource allocation (FDRA); determining whether the DCI is a single direction DCI or a bi-directional DCI based on whether the FDRA points to an uplink sub-band, and/or a downlink sub-band; and communicating in accordance with the DCI.

Aspect 2: The method of Aspect 1, further comprising decoding the DCI based on a first radio network temporary identifier (RNTI) dedicated to the DCI when scheduling both uplink and downlink communications.

Aspect 3: The method of Aspect 1 or 2, in which the FDRA comprises a Type Zero FDRA with a bitmap, and the determining further comprises determining the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band.

Aspect 4: The method of Aspect 1 or 2, in which the FDRA comprises a Type One FDRA with a resource indicator value (RIV), and the determining further comprises determining the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band.

Aspect 5: The method of any of the preceding Aspects, in which the DCI is for scheduling uplink and downlink in a same slot.

Aspect 6: The method of any of the preceding Aspects, in which the TDRA points to a row in a radio resource control (RRC) configured table including a potential first TDRA for uplink and a potential second TDRA for downlink.

Aspect 7: The method of any of the preceding Aspects, in which the TDRA includes a start and length indication value (SLIV) for uplink and for downlink, the method further comprising receiving a mapping between the SLIV, downlink allocations, and uplink allocations.

Aspect 8: The method of any of the preceding Aspects, further comprising applying a guard time between receiving a physical downlink shared channel (PDSCH) and transmitting a physical uplink shared channel (PUSCH).

Aspect 9: The method of any of the preceding Aspects, in which the TDRA includes a start and length indication value (SLIV) with uplink bits in a first field and downlink bits in a second field.

Aspect 10: The method of any of the preceding Aspects, in which the DCI is for scheduling uplink and downlink in multiple slots.

Aspect 11: The method of any of the preceding Aspects, in which the TDRA includes a first TDRA for downlink that is the same as a second TDRA for uplink.

Aspect 12: The method of any of the Aspects 1-10, in which the TDRA includes bits mapped to an uplink TDRA and bits mapped to a downlink TDRA.

Aspect 13: The method of any of the preceding Aspects, further comprising receiving a first mapping between uplink parameters and fields of the DCI, as well as a second mapping between downlink parameters and fields of the DCI.

Aspect 14: The method of any of the preceding Aspects, further comprising receiving a configured offset for one of the uplink parameters relative to a reference parameter, the offset and reference parameter indicating one of the downlink parameters and one of the uplink parameters.

Aspect 15: The method of any of the preceding Aspects, further comprising receiving a configuration for a pair of uplink and downlink parameters, the DCI pointing to the configuration.

Aspect 16: The method of any of the preceding Aspects, in which uplink parameters and downlink parameters are a function of the FDRA and the TDRA.

Aspect 17: A method of wireless communication by a network component, comprising: transmitting downlink control information (DCI) including an uplink grant and a downlink grant, the DCI indicating a time domain resource allocation (TDRA) and a frequency domain resource allocation (FDRA), the DCI indicating whether the DCI is a single direction DCI or a bi-directional DCI based on whether the FDRA points to an uplink sub-band, and/or a downlink sub-band; and communicating in accordance with the DCI.

Aspect 18: The method of Aspect 17, further comprising encoding the DCI based on a first radio network temporary identifier (RNTI) dedicated to the DCI when scheduling both uplink and downlink communications.

Aspect 19: The method of Aspect 17 or 18, in which the FDRA comprises a Type Zero FDRA with a bitmap, and the DCI indicates the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band.

Aspect 20: The method of Aspect 17 or 18, in which the FDRA comprises a Type One FDRA with a resource indicator value (RIV), and the DCI indicates the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band.

Aspect 21: The method of any of the Aspects 17-20, in which the DCI is for scheduling uplink and downlink in a same slot.

Aspect 22: The method of any of the Aspects 17-21, in which the TDRA points to a row in a radio resource control (RRC) configured table including a potential first TDRA for uplink and a potential second TDRA for downlink.

Aspect 23: The method of any of the Aspects 17-21, in which the TDRA includes a start and length indication value (SLIV) for uplink and for downlink, the method further comprising transmitting a mapping between the SLIV, downlink allocations, and uplink allocations.

Aspect 24: The method of any of the Aspects 17-23, further comprising configuring a guard time between receiving a physical downlink shared channel (PDSCH) and transmitting a physical uplink shared channel (PUSCH).

Aspect 25: The method of any of the Aspects 17-24, in which the TDRA includes a start and length indication value (SLIV) with uplink bits in a first field and downlink bits in a second field.

Aspect 26: The method of any of the Aspects 17-25, in which the DCI is for scheduling uplink and downlink in multiple slots.

Aspect 27: The method of any of the Aspects 17-26, in which the TDRA includes a first TDRA for downlink that is the same as a second TDRA for uplink.

Aspect 28: The method of any of the Aspects 17-26, in which the TDRA includes bits mapped to an uplink TDRA and bits mapped to a downlink TDRA.

Aspect 29: The method of any of the Aspects 17-28, further comprising transmitting a first mapping between uplink parameters and fields of the DCI, as well as a second mapping between downlink parameters and fields of the DCI.

Aspect 30: The method of any of the Aspects 17-29, further comprising transmitting a configured offset for one of the uplink parameters relative to a reference parameter, the offset and reference parameter indicating one of the downlink parameters and one of the uplink parameters.

Aspect 31: The method of any of the Aspects 17-28, further comprising transmitting a configuration for a pair of uplink and downlink parameters, the DCI pointing to the configuration.

Aspect 32: The method of any of the Aspects 17-31, in which uplink parameters and downlink parameters are a function of the FDRA and the TDRA.

Aspect 33: An apparatus for wireless communication, comprising: a memory; and at least one processor coupled to the memory, the at least one processor configured: to receive a downlink control information (DCI) including an uplink grant and a downlink grant, the DCI indicating a time domain resource allocation (TDRA) and a frequency domain resource allocation (FDRA); to determine whether the DCI is a single direction DCI or a bi-directional DCI based on whether the FDRA points to an uplink sub-band, and/or a downlink sub-band; and to communicate in accordance with the DCI.

Aspect 34: The apparatus of Aspect 33, in which the at least one processor is further configured to decode the DCI based on a first radio network temporary identifier (RNTI) dedicated to the DCI when scheduling both uplink and downlink communications.

Aspect 35: The apparatus of Aspect 33 or 34, in which the FDRA comprises a Type Zero FDRA with a bitmap, and t the at least one processor is further configured to determine by determining the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band.

Aspect 36: The apparatus of Aspect 33 or 34, in which the FDRA comprises a Type One FDRA with a resource indicator value (RIV), and the at least one processor is further configured to determine by determining the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band.

Aspect 37: The apparatus of any of the Aspects 33-36, in which the DCI is for scheduling uplink and downlink in a same slot.

Aspect 38: The apparatus of any of the Aspects 33-37, in which the TDRA points to a row in a radio resource control (RRC) configured table including a potential first TDRA for uplink and a potential second TDRA for downlink communications.

Aspect 39: The apparatus of any of the Aspects 33-37, in which the TDRA includes a start and length indication value (SLIV) for uplink and for downlink, the at least one processor is further configured to receive a mapping between the SLIV, downlink allocations, and uplink allocations.

Aspect 40: The apparatus of any of the Aspects 33-39, in which the at least one processor is further configured to apply a guard time between receiving a physical downlink shared channel (PDSCH) and transmitting a physical uplink shared channel (PUSCH).

Aspect 41: The apparatus of any of the Aspects 33-40, in which the TDRA includes a start and length indication value (SLIV) with uplink bits in a first field and downlink bits in a second field.

Aspect 42: The apparatus of any of the Aspects 33-41, in which the DCI is for scheduling uplink and downlink in multiple slots.

Aspect 43: The apparatus of any of the Aspects 33-42, in which the TDRA includes a first TDRA for downlink that is the same as a second TDRA for uplink.

Aspect 44: The apparatus of any of the Aspects 33-42, in which the TDRA includes bits mapped to an uplink TDRA and bits mapped to a downlink TDRA.

Aspect 45: The apparatus of any of the Aspects 33-44, in which the at least one processor is further configured to receive a first mapping between uplink parameters and fields of the DCI, as well as a second mapping between downlink parameters and fields of the DCI.

Aspect 46: The apparatus of any of the Aspects 33-45, in which the at least one processor is further configured to receive a configured offset for one of the uplink parameters relative to a reference parameter, the offset and reference parameter indicating one of the downlink parameters and one of the uplink parameters.

Aspect 47: The apparatus of any of the Aspects 33-45, in which the at least one processor is further configured to receive a configuration for a pair of uplink and downlink parameters, the DCI pointing to the configuration.

Aspect 48: The apparatus of any of the Aspects 33-47, in which uplink parameters and downlink parameters are a function of the FDRA and the TDRA.

Aspect 49: An apparatus for wireless communication, comprising: a memory; and at least one processor coupled to the memory, the at least one processor configured: to transmit downlink control information (DCI) including an uplink grant and a downlink grant, the DCI indicating a time domain resource allocation (TDRA) and a frequency domain resource allocation (FDRA), the DCI indicating whether the DCI is a single direction DCI or a bi-directional DCI based on whether the FDRA points to an uplink sub-band, and/or a downlink sub-band; and to communicate in accordance with the DCI.

Aspect 50: The apparatus of Aspect 49, in which the at least one processor is further configured to encode the DCI based on a first radio network temporary identifier (RNTI) dedicated to the DCI when scheduling both uplink and downlink communications.

Aspect 51: The apparatus of Aspect 49 or 50, in which the FDRA comprises a Type Zero FDRA with a bitmap, and the DCI indicates the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band.

Aspect 52: The apparatus of Aspect 49 or 50, in which the FDRA comprises a Type One FDRA with a resource indicator value (RIV), and the DCI indicates the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band.

Aspect 53: The apparatus of any of the Aspects 49-52, in which the DCI is for scheduling uplink and downlink in a same slot.

Aspect 54: The apparatus of any of the Aspects 49-53, in which the TDRA points to a row in a radio resource control (RRC) configured table including a potential first TDRA for uplink and a potential second TDRA for downlink.

Aspect 55: The apparatus of any of the Aspects 49-53, in which the TDRA includes a start and length indication value (SLIV) for uplink and for downlink, the method further comprising transmitting a mapping between the SLIV, downlink allocations, and uplink allocations.

Aspect 56: The apparatus of any of the Aspects 49-55, in which the at least one processor is further configured to configure a guard time between receiving a physical downlink shared channel (PDSCH) and transmitting a physical uplink shared channel (PUSCH).

Aspect 57: The apparatus of any of the Aspects 49-56, in which the TDRA includes a start and length indication value (SLIV) with uplink bits in a first field and downlink bits in a second field.

Aspect 58: The apparatus of any of the Aspects 49-57, in which the DCI is for scheduling uplink and downlink in multiple slots.

Aspect 59: The apparatus of any of the Aspects 49-58, in which the TDRA includes a first TDRA for downlink that is the same as a second TDRA for uplink.

Aspect 60: The apparatus of any of the Aspects 49-58, in which the TDRA includes bits mapped to an uplink TDRA and bits mapped to a downlink TDRA.

Aspect 61: The apparatus of any of the Aspects 49-60, in which the at least one processor is further configured to transmit a first mapping between uplink parameters and fields of the DCI, as well as a second mapping between downlink parameters and fields of the DCI.

Aspect 62: The apparatus of any of the Aspects 49-61, in which the at least one processor is further configured to transmit a configured offset for one of the uplink parameters relative to a reference parameter, the offset and reference parameter indicating one of the downlink parameters and one of the uplink parameters.

Aspect 63: The apparatus of any of the Aspects 49-61, in which the at least one processor is further configured to transmit a configuration for a pair of uplink and downlink parameters, the DCI pointing to the configuration.

Aspect 64: The apparatus of any of the Aspects 49-63, in which uplink parameters and downlink parameters are a function of the FDRA and the TDRA.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a user equipment (UE), comprising:
receiving downlink control information (DCI) including an uplink grant and a downlink grant, the DCI indicating a time domain resource allocation (TDRA) and a frequency domain resource allocation (FDRA);
determining whether the DCI is a single direction DCI or a bi-directional DCI based on whether the FDRA points to an uplink sub-band, and/or a downlink sub-band; and
communicating in accordance with the DCI.

2. The method of claim 1, further comprising decoding the DCI based on a radio network temporary identifier (RNTI) dedicated to the DCI when scheduling both uplink and downlink communications.

3. The method of claim 1, in which the FDRA comprises a Type Zero FDRA with a bitmap, and the determining further comprises determining the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band.

4. The method of claim 1, in which the FDRA comprises a Type One FDRA with a resource indicator value (RIV), and the determining further comprises determining the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band.

5. The method of claim 1, in which the DCI is for scheduling uplink and downlink communications in a same slot.

6. The method of claim 5, in which the TDRA points to a row in a radio resource control (RRC) configured table including a potential first TDRA for uplink communications and a potential second TDRA for downlink communications.

7. The method of claim 5, in which the TDRA includes a start and length indication value (SLIV) for uplink communications and for downlink communications, the method further comprising receiving a mapping between the SLIV, downlink allocations, and uplink allocations.

8. The method of claim 5, further comprising applying a guard time between receiving a physical downlink shared channel (PDSCH) and transmitting a physical uplink shared channel (PUSCH).

9. The method of claim 5, in which the TDRA includes a start and length indication value (SLIV) with uplink bits in a first field and downlink bits in a second field.

10. The method of claim 1, in which the DCI is for scheduling uplink and downlink communications in multiple slots.

11. The method of claim 10, in which the TDRA includes a first TDRA for downlink communications that is the same as a second TDRA for uplink communications.

12. The method of claim 10, in which the TDRA includes bits mapped to an uplink TDRA and bits mapped to a downlink TDRA.

13. The method of claim 1, further comprising receiving a first mapping between uplink parameters and fields of the DCI, as well as a second mapping between downlink parameters and fields of the DCI.

14. The method of claim 13, further comprising receiving a configured offset for one of the uplink parameters relative to a reference parameter, the offset and the reference parameter indicating one of the downlink parameters and one of the uplink parameters.

15. The method of claim 1, further comprising receiving a configuration for a pair of uplink and downlink parameters, the DCI pointing to the configuration.

16. The method of claim 1, in which uplink parameters and downlink parameters are a function of the FDRA and the TDRA.

17. An apparatus for wireless communication by a user equipment (UE), comprising:
a memory; and
at least one processor coupled to the memory, the at least one processor configured:
to receive downlink control information (DCI) including an uplink grant and a downlink grant, the DCI indicating a time domain resource allocation (TDRA) and a frequency domain resource allocation (FDRA);
to determine whether the DCI is a single direction DCI or a bi-directional DCI based on whether the FDRA points to an uplink sub-band, and/or a downlink sub-band; and
to communicate in accordance with the DCI.

18. The apparatus of claim 17, in which the at least one processor is further configured to decode the DCI based on a radio network temporary identifier (RNTI) dedicated to the DCI when scheduling both uplink and downlink communications.

19. The apparatus of claim 17, in which the FDRA comprises a Type Zero FDRA with a bitmap, and the determining further comprises determining the FDRA is for a physical downlink shared channel (PDSCH) when a value of any bit in the bitmap corresponds to any resource block group (RBG) in the downlink sub-band, and the FDRA is for a physical uplink shared channel (PUSCH) when the value of any bit in the bitmap corresponds to any RBG in the uplink sub-band.

20. The apparatus of claim 17, in which the FDRA comprises a Type One FDRA with a resource indicator value (RIV), and the determining further comprises determining the FDRA is for a physical downlink shared channel (PDSCH) when the RIV corresponds to any resource block group (RBG) in the downlink sub-band, and the FDRA is for a physical uplink shared channel (PUSCH) when the RIV corresponds to any RBG in the uplink sub-band.

21. The apparatus of claim 17, in which the DCI is for scheduling uplink and downlink communications in a same slot.

22. The apparatus of claim 21, in which the TDRA points to a row in a radio resource control (RRC) configured table including a potential first TDRA for uplink communications and a potential second TDRA for downlink communications.

23. The apparatus of claim 21, in which the TDRA includes a start and length indication value (SLIV) for uplink communications and for downlink communications, the method further comprising receiving a mapping between the SLIV, downlink allocations, and uplink allocations.

24. The apparatus of claim 21, in which the at least one processor is further configured to apply a guard time between receiving a physical downlink shared channel (PDSCH) and transmitting a physical uplink shared channel (PUSCH).

25. The apparatus of claim 21, in which the TDRA includes a start and length indication value (SLIV) with uplink bits in a first field and downlink bits in a second field.

26. The apparatus of claim 17, in which the DCI is for scheduling uplink and downlink communications in multiple slots.

27. The apparatus of claim 26, in which the TDRA includes a first TDRA for downlink communications that is the same as a second TDRA for uplink communications.

28. The apparatus of claim 26, in which the TDRA includes bits mapped to an uplink TDRA and bits mapped to a downlink TDRA.

29. The apparatus of claim 17, in which the at least one processor is further configured to receive a first mapping between uplink parameters and fields of the DCI, as well as a second mapping between downlink parameters and fields of the DCI.

30. The apparatus of claim 29, in which the at least one processor is further configured to receive a configured offset for one of the uplink parameters relative to a reference parameter, the offset and the reference parameter indicating one of the downlink parameters and one of the uplink parameters.
